(19) United States
(12) Patent Application Publication
(10) Pub. No.: US 2020/0283942 A1
(43) Pub. Date: Sep. 10, 2020

(54) Washing machine suppressing the vibration

(71) Applicant: Choong-Hyun Kim, Seoul (KR)

(72) Inventor: Choong-Hyun Kim, Seoul (KR)

(21) Appl. No.: 16/290,978

(22) Filed: Mar. 4, 2019

(51) Int. Cl. D06F 37/20; F16F 15/02

(52) U.S. Cl. CPC D06F 37/20; F16F 15/02

(57) ABSTRACT

A washing machine comprises a main body and a weight mass base; a tub provided within the main body; a rotatable drum mounted in the tub; a motor to rotate the drum; and a weight mass base located at the bottom of the main body of a washing machine; wires, belts, straps or nets and the like wrapping around the tub and connecting tightly in tension to the clips of the frame in the main body to increase the main body's weight including the tub with laundry and water and the weight of the motor additionally and transfer the added weight to the weight mass base disposed at the bottom of the washing machine so as the total weight force becomes greater than the dynamic force generating vibration of the washing machine and suppresses the vibration of the tub and the drum more efficiently.

### BACKGROUND OF THE INVENTION

### Field of the Invention

The present invention relates to a washing machine, and more particularly, to a washing machine having an apparatus for forcibly suppressing vibration generated in a rotating washing drum of a washing tub and reducing noise generated by vibration.

### Prior Art

Generally, a conventional washing machine vibration noise reduction device has only slightly mitigated vibrations and noise by fixing one or more counter weights to one part in the washing machine body or various parts constituting the washing machine. When parts with counterweights are vibrated, the entire washing machine must be vibrated passively and dependently.

A similar or greater force will be required in order to reduce or cancel the vibration occurred by the dynamic force caused by the mismatch between the center of gravity of the rotating drum and the rotary shaft during the washing and dewatering process of the washing machine in the prior art.

However, in the prior art, vibration and noise generated in rotation of the rotary washing drum during the washing and dehydrating process are mainly mitigated by using suspension system, counter weight, counter balancer and the like.

That is, in the prior art, the force which is actively and forcibly applied to the outer tub enclosing the rotating inner drum to minimize or cancel the vibration or noise occurred by the rotating inner drum cannot be greater or equal to the dynamic force generated by the rotating inner drum during the spin cycle so vibration and noise can never be significantly reduced or canceled in the prior art.

In addition, by using suspension device such as damper, counter balancer, counter weight, or the like is a conventional technique of mitigating vibration and noise in a passive and minimal manner and the manufacturing and maintenance cost and the weight of the washing machine can be greatly increased. The weight of some washing machines is about 100 Kg, which caused high cost and difficulty and inconvenience for handling and transportation of washing machines.

### SUMMARY

In the washing machine of the present invention, in order to reduce the vibration generated by the dynamic force caused by the mismatch between the center of gravity and the rotating shaft of the rotating drum during the washing and dewatering cycles of the washing machine, the external washing tub enclosing the rotating washing drum is wrapped, secured and connected to the heavy weight mass base at the bottom of the washing machine and the washing machine main body by wires, nets, belts or straps and the like. The force of the total weight of the weight mass base and the washing machine's weight including the laundry and water in the drum and the motor is greater than or at least equal to the dynamic force occurred by the mismatch between the center of gravity and the rotating shaft of the rotating drum during the washing and dewatering cycles of the washing machine and causing vibration and noise.

The dynamic force causing vibration and noise is suppressed or cancelled off aggressively and forcibly by the total weight of the heavy weight mass base at the bottom of the washing machine and the washing machine's whole weight including the laundry and water and the motor, so the vibration and the noise of the washing machine will be remarkably reduced compared to the prior art.

According to the present invention, the heavy weight mass base of the present invention is placed at the bottom of the washing machine, instead of fixing one or more counter weights to one place or various parts constituting the washing machine as in the prior art.

Since the weight mass base of the present invention is attachable and detachable to the frame of the washing machine, the weight mass base is separated and transported during transportation, and can be assembled at the final installation site, thereby facilitating comfortable handling and transportation, so reducing accidents, injuries, and damage to the washing machine.

Benefits of the Present Invention

1. Washing machine vibration and noise are reduced significantly so that increases customer satisfaction and reduces claims.
2. Reduction of manufacturing cost by reducing expensive parts for washing machine vibration and noise reduction causes lower the consumer price significantly and increases consumer satisfaction.
3. Failure rate of the washing machine is reduced due to reduction of components for vibration and noise reduction of washing machine
4. Vibration and noise reduction of washing machine extends the life of parts of the washing machine.
5. It is possible to secure idle space, and to reduce the volume of the washing machine body or to enlarge the volume of the washing capacity of the washing machine due to the parts reduced such as springs, dampers and counterweights for vibration prevention.
6. Total weight of the main body of the washing machine except the separable weight mass base can be reduced due to the reduced expensive parts such as springs, dampers, counterweights etc. to prevent vibration.
7. Reduction of electric energy due to the weight reduction of the tub of the washing machine.

### DESCRIPTION OF DRAWINGS

The above and other aspects of the present invention will become more apparent and readily understood from the following description of the preferred embodiments in conjunction with the accompanying drawings of which:

FIG. 1 is a sectional view of a front loading washing machine in accordance with one embodiment;

FIG. 2 is a top view of a front loading washing machine illustrating main components of the present invention in accordance with the embodiment;

FIG. 3 is a sectional view of a top loading washing machine in accordance with another embodiment;

FIG. 4 is a top view of a top loading washing machine illustrating main components of the present invention in accordance with the embodiment;

### DETAILED DESCRIPTION

The foregoing and other objects, features, aspects and advantages of the present invention will be described in detail through embodiments described hereinafter in conjunction with the accompanying drawings. However, embodiments of the present invention may be implemented in many different forms and should not be limited to the embodiments set forth herein. Rather, these embodiments are provided so that this invention will be thorough and complete, and the scope of the invention will convey to those skilled people in the art or science and are defined by the claims of the present invention. Throughout the description, the same reference numerals will be used to designate the same or like components.

Hereinafter, a washing machine according to embodiments of the present invention will be described with reference numerals to the accompanying drawings.

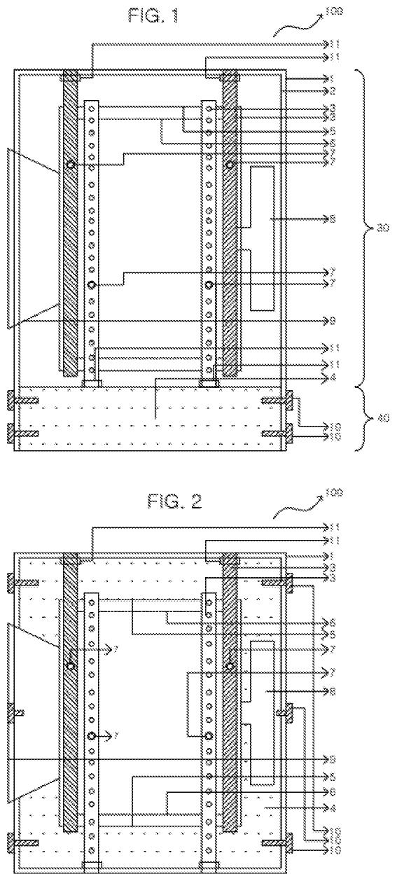

FIG. 1 is a sectional view and FIG. 2 is a top view of a front-loading washing machine in accordance with one embodiment illustrating main components of the present invention in accordance with the embodiment.

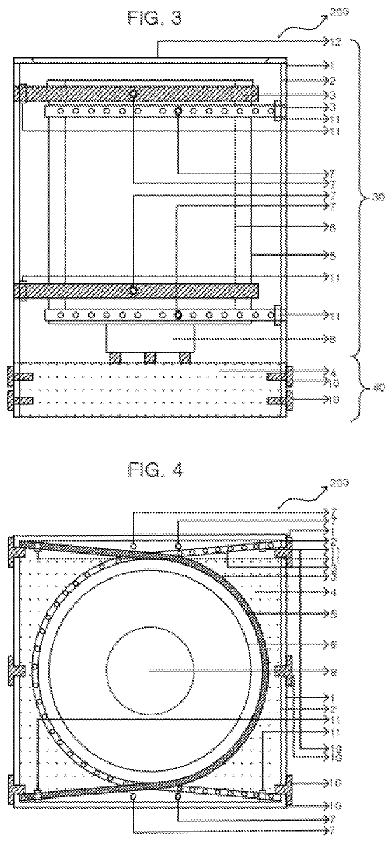

FIG. 3 is a sectional view and FIG. 4 is a top view of a top-loading washing machine in accordance with another embodiment illustrating main components of the present invention in accordance with the embodiment.

As shown in FIGS. 1, 2, 3 and 4, a washing machine 100 and 200 in accordance with this embodiment includes a washing machine case 1 forming the external appearance of the washing machine 100 and 200, a door 9 installed on the front for the front-loading and on the top for the top-loading of the washing machine case 1 respectively to receive laundry, a frame 2 disposed inside the washing machine case 1, a tub 5 disposed within the main body 30, a rotating inner drum 6 enclosed within the tub 5, a motor 8 to rotate the inner drum 6, wires, belts, straps or nets and the like 3 are wrapping around the tub 5 and connecting tightly in tension to the clips 11, clips 11 attached on the frame 2, sensor units 7 attached on wires, belts, straps or nets and the like 3, a weight mass base 40 located and assembled at the bottom of the washing machine case 1, bolts 10 located at the bottom of the washing machine case 1 connecting the weight mass base 40 and the frame 2 of the washing machine 100 and 200.

A door 9 is installed on the front and a lid 9 is installed on the top of the washing machine case 1 respectively to receive laundry into the opening of the tub 5.

A frame 2 disposed inside the washing machine case 1 is attached to the inside of the washing machine case 1 and is attachable or detachable to the weight mass base 40 by bolts 10.

A rotating inner drum 6 is mounted within the tub 5 which disposed within the main body 30, and is wrapped by wires, belts, straps or nets and the like 3, and the ends of the wires, belts, straps or nets and the like 3 are connected tightly in tension to the clips 11 to transfer the weight of the tub 5 and the rotating inner drum 6 including the laundry and water in it and the weight of the motor 8 to the total weight of the main body 30 additionally.

A rotating inner drum 6 mounted within the tub 5 receives laundry and water, which may cause the mismatch between the center of gravity and the rotating shaft of the rotating drum 6 during the washing and dewatering cycles of the washing machine 100, and may generate vibration and noise.

A motor 8 is mounted at the end of the tub and connected to the rotating drum 6 by a drive shaft to rotate the inner drum 6.

Wires, belts, straps or nets and the like 3 wrap around the tub 5 and the ends of the wires, belts, straps or nets and the like 3 connect tightly in tension to the clips 11 to transfer the weight of the tub 5 and the rotating inner drum 6 including the laundry and water in it and the weight of the motor 8 to the total weight of the main body 30 additionally.

Clips 11 attached on the frame 2 hold the ends of the wires, belts, straps or nets and the like 3 tightly with tension which wrap around the tub 5 wherein the rotating inner drum 6 is mounted and receives laundry and water and the motor 8 is connected.

Sensor units 7 attached on wires, belts, straps or nets and the like 3, wherein batteries are enclosed, and they detect the tension or worn out status of the wires, belts, straps or nets and the like 3 and send the data to the user.

A weight mass base 40 located and interlocked by bolt and nut set or pin-lock and the like 10 at the bottom of the frame 2 of a washing machine 100 and 200 respectively is connected to the main body 30.

The wires, belts, straps or nets and the like 3 which wrap around the tub 5, and the ends of wires, belts, straps or nets and the like 3 are connected tightly with tension to the clips 11 of the frame 2 in the main body 30 so as to transfer the weight of the main body 30 including the laundry and water in the tub 5 and the weight of the motor 8 to the weight mass base 40 additionally.

Bolts 10 located at the bottom of the washing machine case 1 interlock the weight mass base 40 and the frame 2 of the washing machine 100.

The invention claimed is:

1. A washing machine comprising a main body and a weight mass base: a tub provided within the main body; a rotatable drum mounted in the tub; a motor to rotate the drum; wires, belts, straps or nets and the like wrap around the tub and connect the wrapped tub tightly in tension to the clips of the frame in the main body; and a weight mass base disposed at the bottom of the main body of a washing machine.

2. The washing machine according to claim 1, wherein the weight mass base located and interlocked by such as bolt and nut set or pin-lock and the like at the bottom of the frame of a washing machine is connected to the main body wherein wires, belts, straps or nets and the like which wrap around the tub and the ends of wires, belts, straps or nets and the like are connected tightly in tension to the clips of the frame in the main body so as to transfer the weight of the main body including the laundry and water in the tub and the weight of the motor to the weight mass base additionally.

3. The washing machine according to claim 2, wherein the total weight force of the weight of the weight mass base and the main body including the tub with the laundry and water is greater than the dynamic force which generated by the unbalanced gravity and the eccentricity of the laundry in the rotating drum so as the total weight force of the washing machine suppresses the vibration of the tub and the drum efficiently.

4. The washing machine according to claim 1, wherein the weight mass base formed from metal or concrete and wrapped with a polymer material can be attachable to the frame or detachable from the frame in the washing machine.

5. The washing machine according to claim 2, wherein the wires, belts, straps or nets and the like have sensor units which detect the tension or worn out status of the wires, belts, straps or nets and the like and send the data to the user.
